(19) United States
(12) Patent Application Publication
(10) Pub. No.: US 2014/0259557 A1
(43) Pub. Date: Sep. 18, 2014

(54) COMBINATION CLAMP, ORGANIZING HARNESS AND DRAPE CLIP

(71) Applicant: Daniel J. Egan, East Falmouth, MA (US)

(72) Inventor: Daniel J. Egan, East Falmouth, MA (US)

(21) Appl. No.: 14/146,413

(22) Filed: Jan. 2, 2014

Related U.S. Application Data
(60) Provisional application No. 61/802,584, filed on Mar. 16, 2013.

(51) Int. Cl. F16L 27/00

(52) U.S. Cl. CPC F16L 27/00
USPC 24/335

(57) ABSTRACT

A surgical organizing device (10) comprises an integrally formed C-clamp (14) for mounting on an IV pole (12), a central portion (28) and a plurality of open-topped horizontal slots (38, 40, 42) for receiving tubing and/or wires used in surgical procedures. Along bottom side edges of the device, apertures (32,34) permit securing respective chains (60, 62) for attaching a drape clip (64), a second spring clip (70) or the like. A bore (30) in said central portion (28) is adapted to hold a suction device, and keep it in a sterile ready-to-use state, until the suction device is needed.

### CROSS-REFERENCE

This application claims priority from my U.S. provisional application Ser. No. 81/802,584 filed 2013 Mar. 16.

### FIELD OF THE INVENTION

The present invention relates to operating room equipment and, more specifically, to a medical device used when administering anesthesia to a medical patient.

### BRIEF FIGURE DESCRIPTION

FIG. 1 is a front perspective view of the clamping/clipping device of the present invention;

FIG. 2 is a rear perspective view of the device;

FIG. 3 is a front view of the device;

FIG. 4 is a rear view of the device;

FIG. 5 is a left side view of the device;

FIG. 6 is a right side view of the device;

FIG. 7 is a top view of the device, looking down into the organizing slots; and

FIG. 8 is a bottom view, show the apertures for attachment of chains.

### DETAILED DESCRIPTION OF THE INVENTION

The device of the present invention is intended to be used, clamped onto a vertically oriented cylindrical pole, of the type used in surgical facilities for supporting bags of sterile fluids administered intravenously, commonly known as an “IV pole.” Therefore, in the following description, the terms “top,” “bottom” and “side” refer to this orientation of the device, and the terms “inner” and “outer” refer to distance from a central longitudinal axis of the IV pole. In the figures, the IV pole is shown with dashed lines because the pole is not itself a part of the present invention. Such an IV pole has a typical diameter of 2 to 4 cm.

In a preferred embodiment, the device 10 is adapted to be temporarily secured to a vertical IV pole 12 by a C-clamp 14 formed at a left end of the device. Clamp 14 has an opening or bight 16 defined by a generally L-shaped projection 18, forming one periphery of the pole-receiving bight 16 and by two contiguous side faces 20 and 22, angled with respect to each other, as shown in FIGS. 7 and 8, which together form an opposing periphery of bight 16. A threaded bolt 24 emerges from a threaded hole (not shown) formed in projection 18, and can be extended across the open bight 16 (preferably aligned with a longitudinal axis of device 10) by rotation in the threaded hole, in order to bear against one side of the IV pole 12, and thereby press the IV pole against the V-shaped surface formed by side faces 20 and 22. Preferably, the angle between faces 20 and 22 is in the range of 75 to 110 degrees, and most preferably is about 90 degrees, as shown in FIGS. 7-8. A pole-remote end of bolt 24 is equipped with a knob 26 of any suitable design, for purposes of rotating bolt 24.

A central portion 28 of device 10 is preferably contiguous with side faces 20 and 22, and is formed with one horizontal bore 30, adapted to receive suction tubing used during administration of anesthesia to a patient, and with first and second edge apertures 32 and 34, for purposes of receiving respective rings which connect to chains 60, 62 for connecting clips to device 10.

A third main portion 36 of device 10, remote from C-clamp 14, is formed with a plurality of open-topped slots for receiving and organizing other “lines” typically used during the administration of anesthesia. In a preferred embodiment, a radially innermost first open-topped slot 38 is adapted to receive blood-pressure lines, a second open-topped slot 40 is adapted to receive electrocardiogram measuring lines, and a radially outermost third open-topped slot 42 is adapted to receive pulse oximetry lines. The slots are defined by upwardly extending partitions, preferably with rounded upper ends, to prevent snagging of the lines or injury to the anesthesia professional during sometimes-hectic surgical procedures. Thus, each slot is generally U-shaped in cross-section. Preferably, first slot 38 is widest of the three because the blood pressure lines are thickest of the lines to be organized, while second slot 40 and third slot 42 are progressively narrower. Partition 39 separates first slot 38 from second slot 40, partition 48 separates second slot 40 from third slot 42, and partition 50 forms the outermost wall of slot 42. As shown in FIG. 4, a bottom wall 46 extends beneath all of the slots, and is contiguous with central portion 28 of device 10. In a preferred embodiment, each slot is about 2 cm wide between partitions, about 3 to 4 cm deep from partition top to bottom wall 46, and 4-5 cm longitudinally.

The clamp designed to adjust to a wide variety of pole circumferences and dimensions. The clamp can be easily adjusted, up or down the height of the IV pole, as needed. Attached to the clamp are two chains 60, 62 with a respective fastener at the chain end. A clamp-proximate end of each chain is attached to the body of the device by a respective ring secured in aperture 32 or 34.

The distal end of the chain is attached to a drape clip 64 having an internal spring 66. The clip at the distal end of the chain is used to fasten an anesthesia drape 68 to the IV pole 12, thus allowing the drape to create a barrier between the sterile surgical field and a non-sterile anesthesia work area. The drape serves to prevent blood, water or anything else, from splashing and contaminating other areas. The extra chain length allows the anesthesia provider to clamp the drape at a desired height, without having to move or raise the body of the clamp that is secured to the IV pole. The chain prevents the inconvenience to the anesthesia professional of having to look for a missing clip, at a possibly inconvenient time.

Optionally, aperture 32 can be used to secure a second connecting ring and a chain 60 to device 10, for purposes of connecting a second spring clip 70. Yankauer suction tubing typically comes with a sterile wrapper of paper and clear film, to prevent bacterial contamination of the Yankauer device. Second clip 70 can be used to keep this sterile wrapper around the Yankauer device while it is crimped for insertion into bore 30, thereby maintaining sterility.

Incorporated into the body of the device is a bore 30 that serves as a holster or docking station for a suction tube which is used in surgical settings to suction out the patient's mouth. In medical practice, the suction through the tube is left “on” at all times and ready for use. This creates a constant, annoying and distracting hissing sound, as air is being sucked into the suction catheter tip. During time intervals between uses, to prevent this sound, the tube is bent or crimped, thus cutting off the airflow and eliminating the annoying sound. When the suction tubing is bent (the suction is still “on” or active) the suction tubing can easily be inserted into the specially-designed bore 30 in the body of the device, thus assuring that it is no longer making the hissing noise, and that it is close at hand when the Yankauer device is needed. As the suction catheter is removed from the bore, harness or docking station, the suction tube is no longer bent; it straightens out, which makes the suction fully active and ready for use. The fact, that the suction-receiving bore 30 is built into the body of the organizing device, improves the accessibility of the suction and keeps it close at hand, in times of urgent need. It also allows the practitioner to dock the suction catheter in a consistent place, and avoids any necessity to have to search for it amongst a clutter of wires, hoses and lines, as is typically present in an operating room.

The elevation (on the pole) of the body of the IV clamp can be adjusted, so as to keep it at an optimal emergency response level which is close to the level of the patient's head. Having one's suction catheter close at hand is critical, and could prevent serious patient aspiration problems, especially during induction into and emergence from the anesthetized state, the times when the patient is most likely to vomit. In a typical operating theater, there are two IV poles used by the anesthesia provider. One pole is near the left side of the patient's head, while the other is near the right side of the patient's head. The IV poles are used, not only to hang IV fluid bags, but also are used almost exclusively by the anesthesia provider, to secure the anesthesia drape in a raised position.

The device also includes a built-in slots or harnesses, to provide the practitioner a place to hang redundant excessively long wires and hoses, thus limiting clutter and tangles of lines. The slots or harnesses, which are preferably is integrally formed with the body of the clamp, allows the practitioner an opportunity to establish order and create a neater, more organized work environment, and a safer work area to contain, or control placement of, EKG wires, blood pressure sensors, pneumatic hoses, pulse oximetry wires, temperature wires and IV lines. The built-in slot or harness could also be used to hang and organize other devices such as stethoscopes, twitch monitors, or IV infusion pumps, IV infusion lines, or arterial blood pressure (B/P) transducers, to allow the practitioner to raise or lower the transducer to the appropriate diagnostic elevation.

When the anesthesia administration is completed, the lines are removed from patient and placed into the organizing slots, working (with reference to the IV pole) from the radially innermost position first, namely blood pressure lines first, EKG lines second, and pulse oximetry wire last.

When starting to administer anesthesia, the reverse sequence is followed.

### What the Device Accomplishes

It prevents the loss or misplacement of the anesthesia drape clip. It allows the practitioner to have the clip securely fastened to the IV pole and always available when needed. It avoids the expense and lost time of frequently having to search for a replacement for a missing clip. It eliminates the practice of using makeshift replacements for clips like tape or inferior fastening devices. It facilitates consistent and reliable use of the clip. It also allows one complete freedom to raise the height of the clip. It also provides a place to secure the suction catheter, a place that is located consistently in the same place. Reliability and safety are improved. It is convenient, located in a critical location next to the patient's head and airway. It allows one to harness and organize one's monitoring devices, wires, pneumatic hoses, IV lines, twitch monitors and stethoscopes.

### How it Works

Once the device is clamped to the IV pole, the clip at the end of the chain should be clipped to the IV pole, above or superior to the body of the IV pole clamp. This clip will secure the anesthesia drape to the IV pole. The design of the body of the clamps allows one to place the suction catheter (bent or crimped) into the hole provided. The design also incorporates a plurality (preferably three) of slots or harnesses, in order to organize redundant or excessively long wires so that the wires do not end up on the floor, or tangled.

### Parts and Components

1) an IV pole clamp with a unibody design that defines a hole to receive a suction hose, and has 3 U-shaped slots or harnesses.

2) A knob that drives a threaded element into engagement with the IV pole, as the knob is turned clockwise.

3) two round ring fasteners, each coupled to a respective (proximate or distal) end of a length of lightweight stainless steel or chromium chain which interconnects the clamp and a clip.

4) drape clip, connected to the ring fastener at the distal end of the chain.

5) a smaller clip, which can be used to clamp a sterile wrapper around a Yankauer suction device, thereby keeping the wrapper from falling off and becoming contaminated.

### What is Conventionally Used in the Field

It is standard practice in many hospitals to use unattached clips or clips for anesthesia drapes. These clips are not secured to the IV pole, so as to prevent them from being easily removed or misplaced.

It is standard practice in many hospitals to fashion a makeshift suction tube holder by using a 10-20 cc syringe, affixed somewhere (never consistently in the same location) onto the anesthesia machine with tape and bandage material, usually not within close proximity.

It is a constant struggle to bring some order into containment of wires and hoses and lines, and to not have them all over the floor. There are no devices known to me which address all these issues.

As a practicing anesthesia provider for over 20 years, I know the clinical application, and the need to incorporate safety, consistency, and reliability into anesthesia practice, in order to achieve a clean, and orderly work environment. When this orderly work environment is accomplished, safety improves and stress levels decrease. The device of the present invention achieves these objectives, by simple but effective features.

What is claimed is:

1. A medical organizing device (10), comprising
a clamp (14) adapted for clamping the device onto a cylindrical support surface (12);
a central device portion (28), coupled to said clamp, and formed with a horizontal bore adapted to receive a folded portion of suction tubing; and
a plurality of open-topped horizontal slots (38, 40, 42) adapted to receive tubing and wires used in surgical procedures.

2. The organizing device of claim 1, wherein said plurality of slots includes
a first slot (38) adapted to receive blood pressure monitoring lines,
a second slot (40) adapted to receive electrocardiogram monitoring lines; and
a third slot (42) adapted to receive pulse oximetry lines.

3. The organizing device of claim 1, further comprising a clip (64) for holding an anesthesia drape (68) on a pole (12),
and a flexible connector (62, 34) to maintain a mechanical connection between said organizing device (10) and said clip (64).

4. The organizing device of claim 1, wherein said clamp (14) comprises
two mutually angled side faces (20, 22) forming one side of a bight (16), and a generally L-shaped projection (16) forming an opposing side of said bight; and
a rotatable bolt (24) capable of adjustment to narrow said bight and thereby to secure a cylindrical object (12) in engagement against said mutually angled side faces (20, 22).

5. The organizing device of claim 1, further comprising
a second clip (70) adapted for maintaining in place a sterile cover around a Yankauer suction device, and
a chain (60) interconnecting said organizing device and said second clip (70).
